(19) United States
(12) Patent Application Publication
(10) Pub. No.: US 2012/0055916 A1
(43) Pub. Date: Mar. 8, 2012

(54) METHOD AND SYSTEM FOR THERMAL TREATMENT OF SUBSTRATES

(75) Inventors: Leon Volfovski, Mountain View, CA (US); Harald Herchen, Los Altos, CA (US); Jay D. Pinson, San Jose, CA (US)

(73) Assignee: Sokudo Co., Ltd., Shimogyo-ku (JP)

(21) Appl. No.: 13/036,915

(22) Filed: Feb. 28, 2011

Related U.S. Application Data
(60) Provisional application No. 61/309,286, filed on Mar. 1, 2010.

(51) Int. Cl. H05B 3/68; H05B 1/00

(52) U.S. Cl. 219/443.1

(57) ABSTRACT

A rapid temperature change (RTC) system includes a bake plate assembly including a heat spreader; a heater substrate coupled to the heat spreader; and a heater layer coupled to the heater substrate. The RTC system also includes a passive chill structure positioned adjacent the bake plate assembly. The passive chill structure is moveable to make physical contact with the heater layer. The passive chill structure includes a chill plate and a thermal pad coupled to the chill plate. The RTC system further includes an active chill structure positioned adjacent the passive chill structure. The passive chill structure is moveable to make physical contact with the active chill structure.

### CROSS-REFERENCES TO RELATED APPLICATIONS

This application claims priority to U.S. Provisional Patent Application No. 61/309,286, filed on Mar. 1, 2010, entitled “Method and System for Thermal Treatment of Substrates,” the disclosure of which is hereby incorporated by reference in its entirety for all purposes.

### BACKGROUND OF THE INVENTION

Semiconductor processing is used to fabricate an enormous variety of semiconductor devices and systems. Some substrate processing techniques involve placing the substrate, such as a semiconductor wafer, on a substrate platform and processing the substrate. These processes can include chemical processes, plasma induced processes, etching, processes, and deposition processes. Typically, these processes are temperature dependent and heating and cooling of the semiconductor substrate during processing is utilized. In order to increase wafer/substrate throughput, heating and/or cooling of substrates and processing equipment in a short time period is desirable. Therefore, there is a need in the art for improved methods and systems related to thermal treatment of substrates.

### SUMMARY OF THE INVENTION

Embodiments of the present invention provide for a rapid temperature change (RTC) capability that is used to reduce or increase the temperature of the substrate heating apparatus (e.g., a bake plate) from a first set point to a second set point in a short time period. In an exemplary embodiment, a temperature change of ±50° C. in less than one minute is achieved. The RTC capability described herein results in many benefits, including higher system throughput.

According to an embodiment of the present invention, a rapid temperature change (RTC) system is provided. The RTC system includes a bake plate assembly including a heat spreader; a heater substrate coupled to the heat spreader; and a heater layer coupled to the heater substrate. The RTC system also includes a passive chill structure positioned adjacent the bake plate assembly. The passive chill structure is moveable to make physical contact with the heater layer. The passive chill structure includes a chill plate and a thermal pad coupled to the chill plate. The RTC system further includes an active chill structure positioned adjacent the passive chill structure. The passive chill structure is moveable to make physical contact with the active chill structure.

Numerous benefits are provided by embodiments of the present invention. These include uniform thermal contact between a passive plate and the heater, a low mechanical impact on the heater, resulting in a reduced impact on the flatness of the heater. Additionally, benefits include fast thermal contact between the passive plate and the active cooling plate, low sensitivity to PCW water temperature, reduced or no adverse effect on process thermal uniformity, reduced or no pulling on RTD or power lead wires, and easy assembly and removal of the bake plate. The inventors anticipate that thermal systems incorporating the designs discussed herein will provide more than five years of working life for the bake plate and RTC assembly.

These and other embodiments of the invention along with many of its advantages and features are described in more detail in conjunction with the text below and attached figures.

### BRIEF DESCRIPTION OF THE DRAWINGS

FIG. 1 is a simplified plot illustrating temperatures of a substrate as a function of time according to an embodiment of the present invention;

FIG. 2 is a simplified illustration of a thermal management system including a bake plate assembly and cooling plates with a rapid temperature change (RTC) capability according to an embodiment of the present invention;

FIG. 3A is a simplified top isometric view of the heat spreader and heater substrate according to an embodiment of the present invention;

FIG. 3B is a simplified bottom isometric view of the heat spreader and heater substrate according to an embodiment of the present invention;

FIG. 4 illustrates plots of RTD temperature versus time for zones of a multi-zone bake plate according to an embodiment of the present invention;

FIG. 5A is a simplified illustration of a passive chill plate according to an embodiment of the present invention;

FIG. 5B is a simplified illustration of a heater shield according to an embodiment of the present invention;

FIG. 5C is a simplified illustration of vacuum path cutouts in the thermal pad according to an embodiment of the present invention; and

FIG. 5D is a simplified illustration of an RTC vacuum assist hook-up according to an embodiment of the present invention.

### DETAILED DESCRIPTION OF THE INVENTION

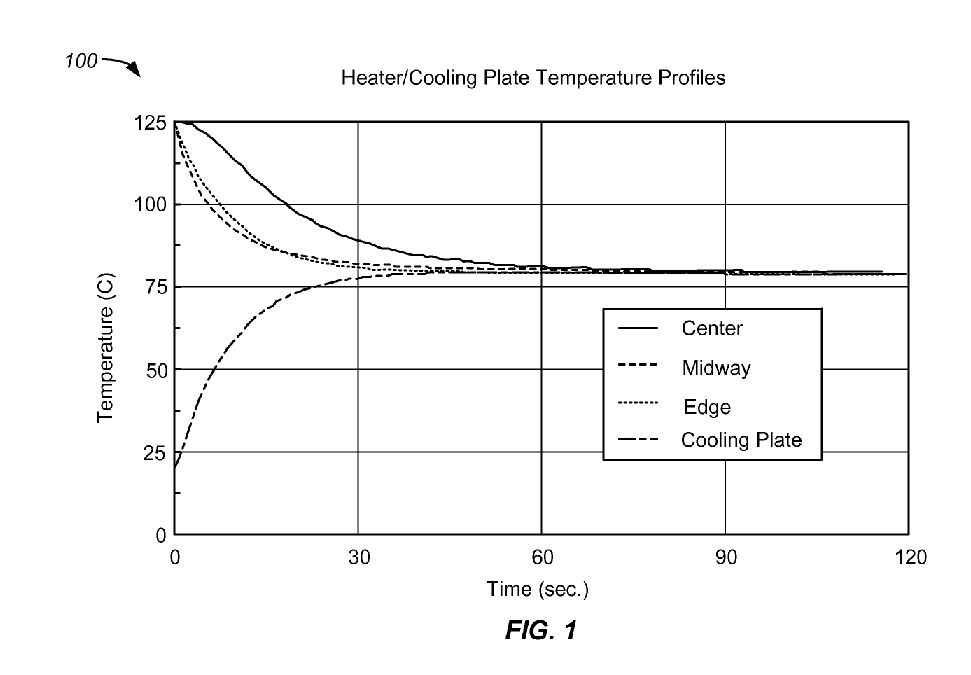

FIG. 1 is a simplified plot illustrating temperatures of a substrate as a function of time. As shown in FIG. 1, the center of the substrate cools more slowly than the midway and edge portions of the substrate. For a multi-zone bake plate, the various zones will cool at different rates. Depending on the flatness of the bottom of the bake plate and how the bake plate engages with the thermal mass used to cool the bake plate, the temperatures of the different zones will decrease differently. Thus, for some of the zones, the temperature controller will need to increase power as the temperature overshoots the temperature set point and decreases to a temperature below the set point. For other zones, the temperature controller will need to operate at lower power as the temperature of the zone decreases slowly to the set point. Embodiments of the present invention reduce this spatial variation of temperature across the substrate as described more fully throughout the present specification.

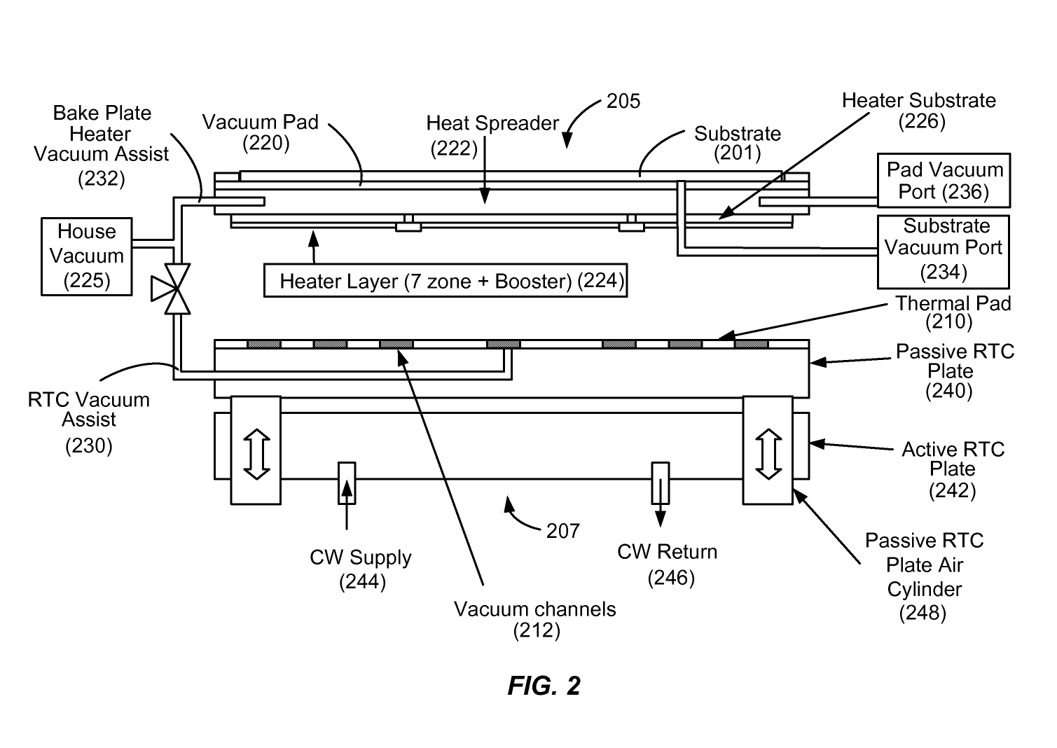

FIG. 2 is a simplified illustration of a thermal management system including a bake plate assembly and cooling plates with a rapid temperature change (RTC) capability according to an embodiment of the present invention. The thermal pad 210 provides for a compliant layer between the bake plate assembly 205 and the chill plate assembly 207 to increase the uniformity of the thermal conductivity as a function of bake plate position. The thermal pad is a 5506S thermally conductive pad available from 3M in one implementation. As an example, the thermal pad can be approximately 0.5-2 mm in thickness depending on the particular application.

The bake plate assembly 205 includes a vacuum pad 220 (e.g., a thermal pad) attached to a heat spreader 222 by vacuum. In an embodiment, the vacuum pad 220 is patterned to provide for proximity pins on the upper surface of the vacuum pad. Although multiple vacuum sources are used to provide vacuum assist to multiple portions of the system, not all of the illustrated vacuum sources are required by embodiments of the present invention. Accordingly, one or more of the illustrated vacuum systems can be utilized alone or in combination. As an example, vacuum assist can be used for the RTC vacuum assist 230 (thermal pad to passive RTC chill plate) only. As another example, the RTC vacuum assist can be used in combination with vacuum to hold and flatten the thermal pad and/or the substrate vacuum assist. As yet another example, these vacuum assists can be combined with the bake plate heater vacuum assist 232, also referred to as a bake plate vacuum assist. One of ordinary skill in the art would recognize many variations, modifications, and alternatives.

The heat spreader 222 provides for high thermal conductivity between the vacuum pad 220 and the heater layer 224, which can be a seven zone heater plus a booster heater. The heat spreader 222 can be made of any suitable material characterized by good thermal conductivity, for example, aluminum, copper, or the like. Additional description related to multi-zone bake plates is provided in commonly assigned U.S. Pat. No. 7,427,728, the disclosure of which is hereby incorporated by reference for all purposes. Thus, embodiments of the present invention provide a multi-zone (e.g., 6 or 7 zone) heater with a booster layer. A heater substrate layer 226 is disposed between the heat spreader 222 and the heater layer 224. The heater substrate layer 226 provides mechanical support for the system. As an example, aluminum is a good material in relation to heat transfer, but is characterized by poor material strength. On the other hand, alumina is characterized by high strength, but poor thermal conductivity. Embodiments of the present invention utilize the good characteristics of both materials to provide a high thermal conductivity heat spreader 222 and a high strength heater substrate 226 to provide a thin mechanical support. As an example, the high strength layer can be alumina or silicon carbide.

The number of zones used in embodiments of the present invention is typically seven zones, but embodiments of the present invention are not limited to this number. As an example, a seven-zone heater can include four peripheral zones, a central zone, and two zones consisting of two halves of an annulus surrounding the central zone. In another embodiment, two concentric annular zones surround the central zone. One of ordinary skill in the art would recognize many variations, modifications, and alternatives.

Preferably, the thickness of the heater substrate 226 is decreased in order to provide a more rapid temperature change despite poor thermal conductivity. At the same time, the strength of the heater substrate should be sufficient to provide mechanical rigidity. Typically, the vacuum pad 220 is made from Kapton or other suitable material. Typically, the initial thickness of the vacuum pad is about 100 μm, with proximity pins formed in the upper surface using a masking and etching technique.

Typically, the thickness of the heat spreader 222 will be in the range of 4 mm-10 mm, for example, 6 mm. Typically, the thickness of the heater substrate 226 will be in the range of 3 mm-4 mm. The bake plate assembly 205 will have a total thickness of 10 mm in some embodiments.

As semiconductor processing operations are characterized by increasing tolerance requirements, the time needed to reach the new set point is decreasing. In order to heat the bake plate to the set point, limitations are associated with the power provided by the zones of a multi-zone bake plate. In order to control small fluctuations in the heater zones, fine control of the heater zones is desirable, which runs counter to provision of fine control. In order to provide for rapid increases in bake plate temperature, embodiments of the present invention provide a booster layer that can provide a temperature increase for all heater zones. The booster layer is integrated into the heater layer and provides for concurrent heating of all heater zones. Thus, the booster provides rapid heating of the entire bake plate while fine tuning of the various zones with fine zone control.

Referring to FIG. 2, a passive RTC plate 240, also referred to as a chill plate is mounted on air cylinders to be moveable in the vertical direction. Other mechanisms for moving the passive chill plate can also be utilized. The top of the passive RTC plate 240 is formed using a thermal pad 210 adapted to make contact with the heater layer 224 forming the bottom of the bake plate assembly 205. Thus, the passive chill plate 240 is moveable and adapted to come into thermal contact with the bake plate assembly 205. The passive chill plate 240 can be fabricated using aluminum or a nickel plated copper 110 alloy that is 10 mm in thickness.

Additional description related to engageable thermal masses is provided in commonly assigned U.S. Pat. No. 7,274,005, the disclosure of which is hereby incorporated by reference in its entirety.

In order to increase the thermal conductivity between system elements and to increase the planarity of the surfaces in thermal contact, including the substrate 204, elements of the bake plate assembly 205, and the passive RTC plate 240, vacuum assist is provided at several levels of the system. A bake plate heater vacuum assist 232 is provided to provide for a continuous vacuum between the heater spreader 222 and the heater substrate 224. The vacuum provides for an improvement in planarity of the bake plate elements and increased planarity and/or thermal conductivity between the bake plate assembly and the passive RTC plate. As a result of the increase in planarity and/or compliance, the temperature spread between the various zones is decreased in comparison to the differences illustrated in FIG. 1.

The bake plate assembly 205 also includes a substrate vacuum port 234 to provide for vacuum chucking of the substrate 201 to the vacuum pad 220. In an embodiment, the substrate vacuum port 234 is operated at about 7 kPa. Operation at about 7 kPa provides benefits, including ensuring long life of the vacuum (e.g., Kapton) pad. Additionally, a pad vacuum port 236 provides vacuum to adhere the vacuum pad 220 to the heat spreader 222. In an embodiment, the pad vacuum port 236 is operated at about 14 kPa. Other vacuum pressures are utilized in other embodiments.

An additional vacuum assist is provided (the RTC vacuum assist 230) to provide for increased planarity and/or thermal conductivity between the thermal pad and the passive RTC plate. In FIG. 2, both the bake plate heater vacuum assist 232 and the RTC vacuum assist 230 are in fluid communication with house vacuum, although other vacuum sources can be utilized depending on the particular implementation. Vacuum channels are formed in the compliant thermal pad 210 to provide for a good seal between the thermal pad 210 and the heater layer 224.

The passive RTC plate 240 is also moveable to contact the active RTC chill plate 242, which is water cooled in the illustrated embodiment, with the chilled water (CW) supply 244 and CW return 246 illustrated. Although not illustrated in FIG. 1, open holes are provided in the passive chill plate and active RTC plates for leads to provide power to the zones and leads to RTD sensors, which are used for closed loop control of the bake zones.

During operation, when the substrate 201 is being heated, the passive chill plate 240 is in thermal contact with the active chill plate 242. In the illustrated embodiment, the passive chill plate is in physical contact with the active chill plate. In order to decrease the set point from a high temperature to a low temperature, the passive chill plate is moved vertically (using, for example, the passive RTC plate air cylinder 248) to engage with the back of the bake plate assembly 205. As discussed above, variations in the flatness of the heater layer 224 and the passive chill plate 240 are compensated for by the compliant thermal pad 210. The electrodes and the lamination associated with the heater layer contribute to these flatness variations that are compensated with by the thermal pad. The compressibility of the thermal pad is typically limited as a result of properties of the material. To increase the softness of the materials, the density of the fine particles inside the pad (e.g., graphite) have to be decreased, reducing the thermal conductivity. Thus, a balance is struck between high thermal conductivity and high compliance.

Embodiments of the present invention differ from conventional approaches in which vacuum is used to change the shape of the thermal pad to conform to the fixed shape of the bake plate. As described throughout the present specification, vacuum assist is used to change the shape of the vacuum pad in contact with the bake plate. Vacuum is used to change the surface profile of the thermal pad 210 coupled to the passive chill plate 240. Typically, vacuum is used to change the shape of an object (e.g., a substrate) that is separate from the chuck having the vacuum. Here, instead of applying the vacuum on a chuck in order the change the shape of something that is separate from the chuck, the vacuum is applied to the passive chill plate in order to change the shape of the thermal pad. The passive chill plate has through holes and the vacuum channels 212 are positioned in light of the position of the various through holes.

In forming the vacuum channels 212 in the thermal pad 210, there are two competing design constraints: a large enough thickness of the thermal pad material to maintain a vacuum in the channel and a small enough thickness to maintain good thermal conductivity for the pad. The inventors have determined that by improving the contact area, the temperature non-uniformity was reduced due to cooling from 12° C. to less than 2° C. and the cooling time reduced by 45%. Typically implementing a temperature change from 140° C. to 90° C. change takes about 150 seconds (100 s cooling/50 s stabilization). Utilizing embodiments of the present invention, only 50 seconds vs. 93 seconds to achieve a temperature drop of 50° C. (i.e., 45% improvement). Additionally, the stabilization time is expected to be reduced by about 70%.

In summary, several vacuum assists are utilized with the bake plate assembly 205 as illustrated in FIG. 1: vacuum is used to attach the vacuum pad to the heat spreader, vacuum is used to straighten the substrate, and vacuum is used to attach the heater plate to the heat spreader. Vacuum to the chuck is provided by vacuum ports in the edges of the chuck (in fluid communication with the substrate vacuum port 234) that pass through passages to the channels formed in the upper surface of the chuck. In an embodiment, vacuum ports (e.g., 6 ports) are provided to provide vacuum to chuck the substrate. The heat spreader 222 includes vacuum channels in both the top and bottom surfaces. The use of vacuum to thermally attach the vacuum pad, the heat spreader, and the heater substrate provide benefits in comparison with conventional approaches including an increase in planarity and cost savings. In comparison with conventional techniques of screwing these structures together, vacuum attachment reduces bowing and curvature associated with mechanical fasteners.

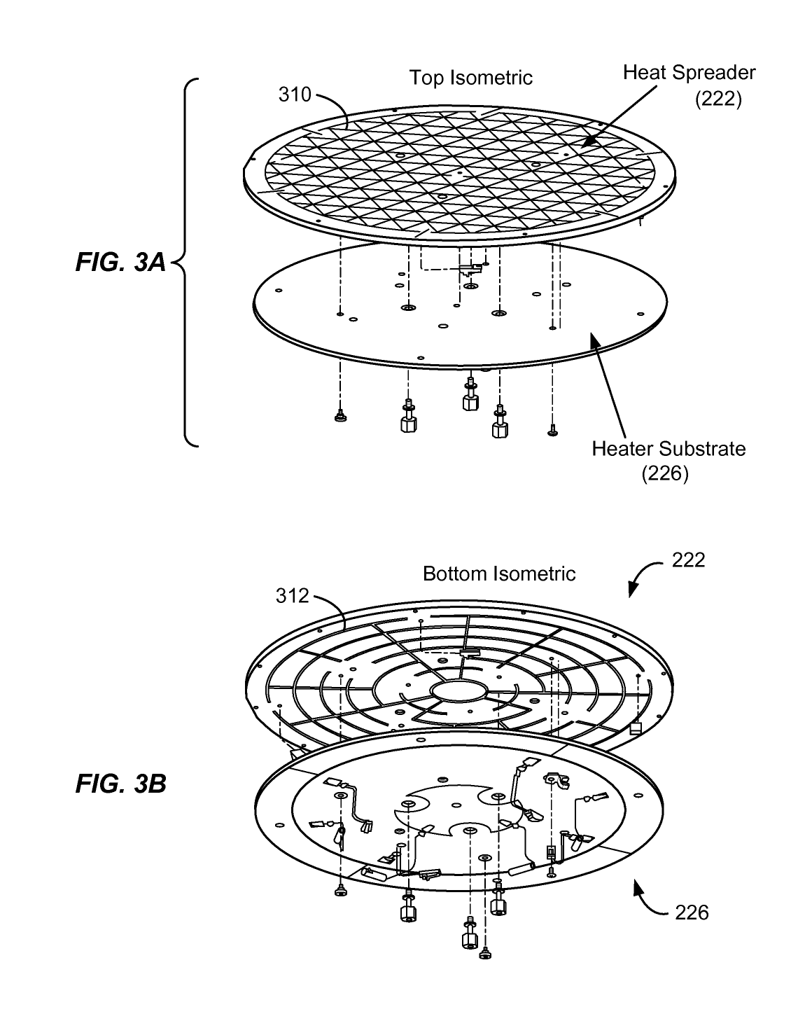

FIG. 3A is a simplified top isometric view of the heat spreader 222 and heater substrate 226 according to an embodiment of the present invention. FIG. 3B is a simplified bottom isometric view of the heat spreader and heater substrate according to an embodiment of the present invention. Referring to FIG. 3A, vacuum channels 310 and 312 are illustrated in the top of the heat spreader and in the bottom of the heat spreader, respectively.

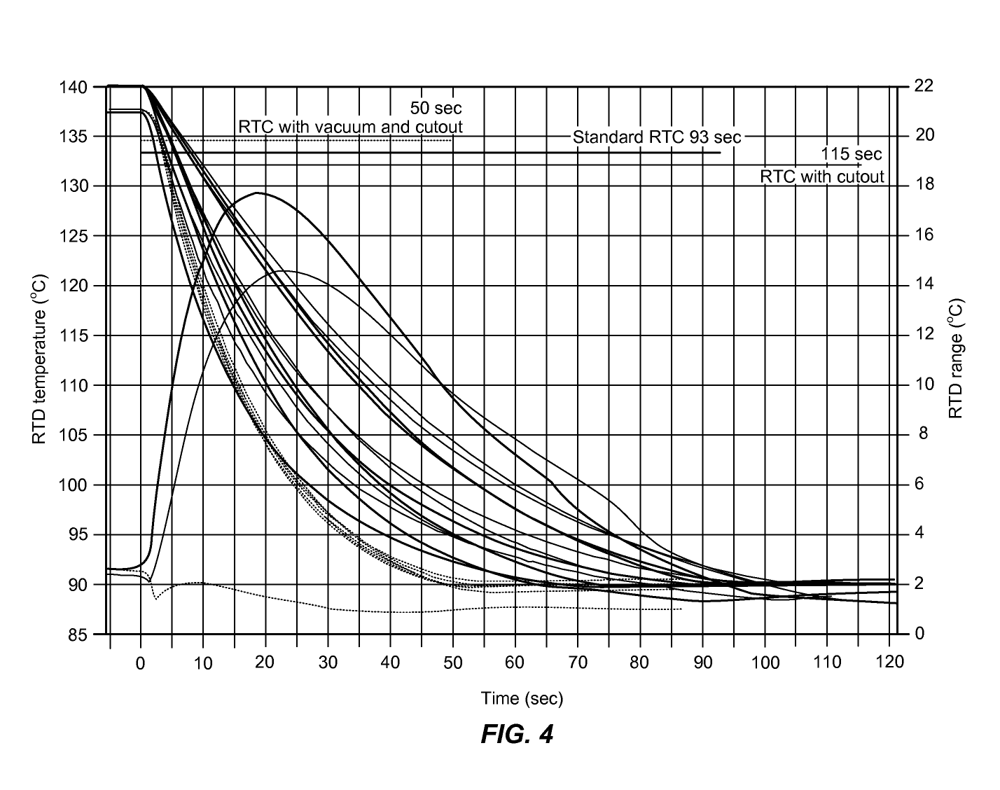

FIG. 4 illustrates plots of RTD temperature versus time for zones of a multi-zone bake plate according to an embodiment of the present invention. Referring to FIG. 4, the time required to reduce the temperature of the bake plate from the first set point to the second set point decreased from 93 seconds to 50 seconds. Additionally, the uniformity between zones was improved markedly as demonstrated by the tight clustering of the red curves in comparison with the green curves. As illustrated in FIG. 4, the temperature difference between heater zone was less than 2° C. and the cooling time was improved by 45%.

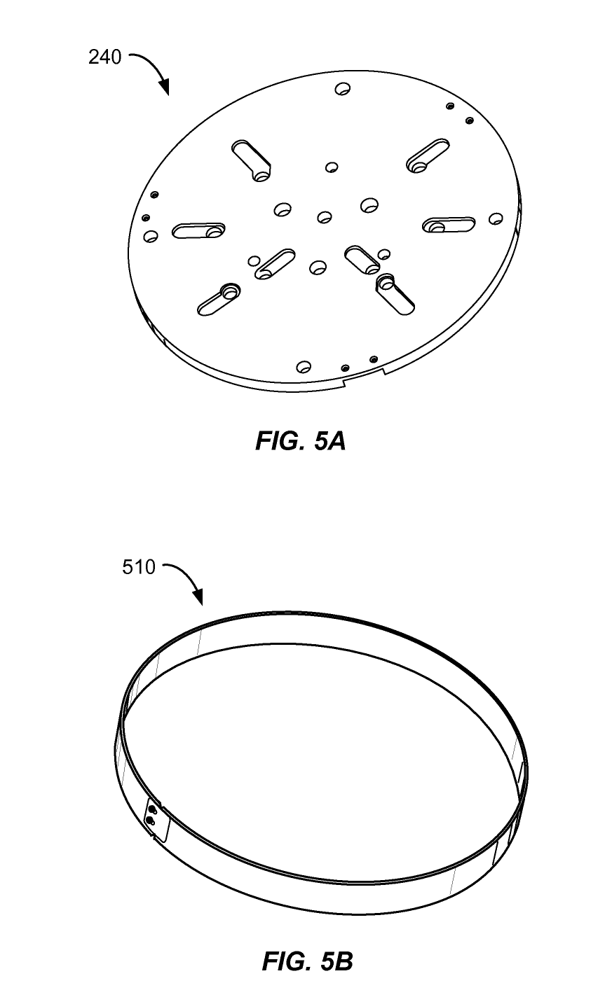

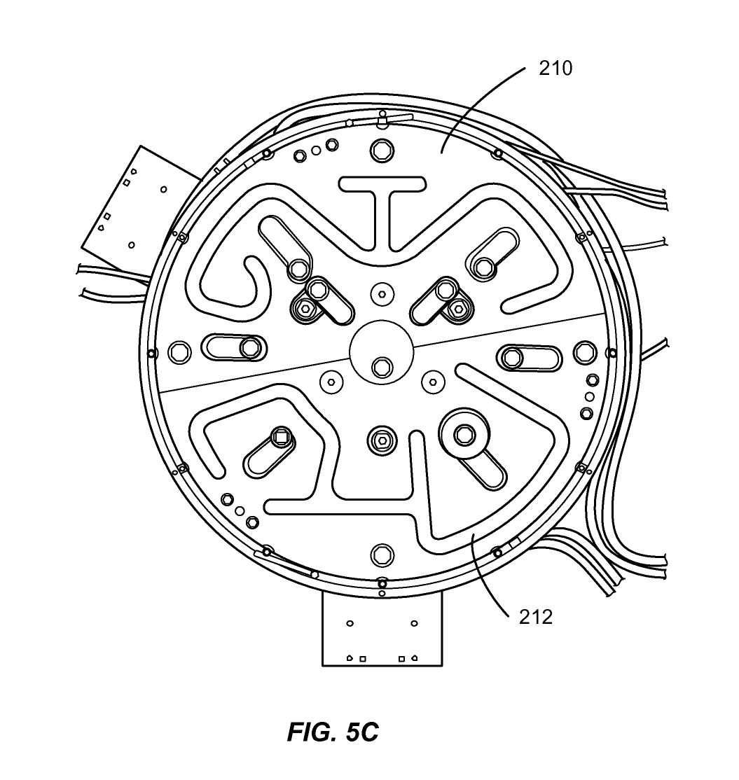

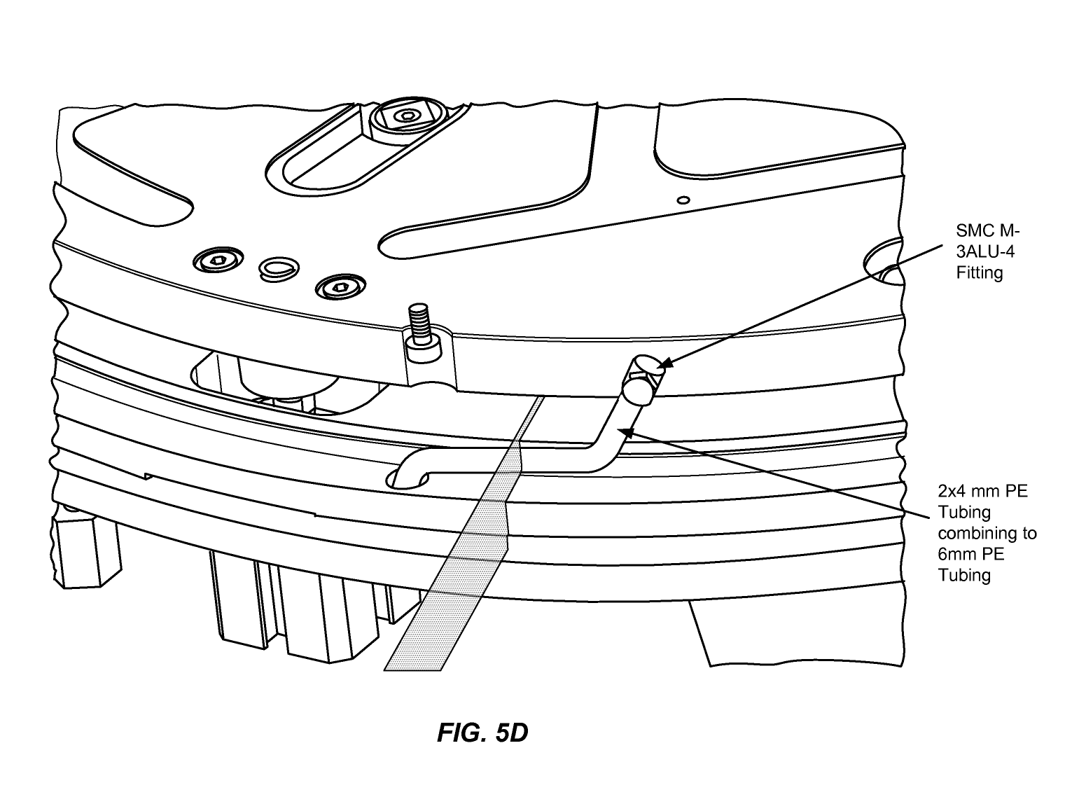

FIG. 5A is a simplified illustration of a passive chill plate 240 and FIG. 5B is a simplified illustration of a heater shield 510 according to an embodiment of the present invention. The heater shield 510 is optional in some embodiments. The passive chill plate 240 includes pass through holes for lift pins, electrical wires, and the like. The heater shield 510 is fabricated from stainless steel that is polished on the interior surfaces in an embodiment.

FIG. 5C is a simplified illustration of vacuum path cutouts in the thermal pad according to an embodiment of the present invention. FIG. 5D is a simplified illustration of an RTC vacuum assist hook-up according to an embodiment of the present invention.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A rapid temperature change (RTC) system comprising:
a bake plate assembly comprising:
a heat spreader;
a heater substrate coupled to the heat spreader; and
a heater layer coupled to the heater substrate;
a passive chill structure positioned adjacent the bake plate assembly, wherein the passive chill structure is moveable to make physical contact with the heater layer, the passive chill structure comprising:
a chill plate; and
a thermal pad coupled to the chill plate; and
an active chill structure positioned adjacent the passive chill structure, wherein the passive chill structure is moveable to make physical contact with the active chill structure.

2. The RTC system of claim 1 wherein the bake plate assembly further comprises a vacuum pad coupled to the heat spreader.

3. The RTC system of claim 2 wherein the vacuum pad is coupled to the heat spreader via a vacuum assist.

4. The RTC system of claim 1 wherein the heat spreader comprises a plate containing at least copper or aluminum and having plate having a thickness between about 5 mm and 10 mm.

5. The RTC system of claim 1 wherein the heater substrate comprises a plate containing alumina and having a thickness between about 2 mm and 5 mm.

6. The RTC system of claim 1 further comprising a bake plate vacuum system, wherein the heat spreader and the heater substrate are coupled using the bake plate vacuum assist.

7. The RTC system of claim 1 wherein the thermal pad is coupled to the chill plate using a vacuum assist.

8. The RTC system of claim 1 wherein the thermal pad is coupled to the chill plate using a bonding agent.

9. The RTC system of claim 1 wherein the passive chill structure is positioned between the active chill structure and the bake plate assembly.

10. The RTC system of claim 1 wherein the heater layer comprises a plurality of independently controlled zones.

11. The RTC system of claim 10 wherein one of the plurality of independently controlled zones comprises a zone overlapping with others of the plurality of independently controlled zones.

12. The RTC system of claim 11 wherein the one of the plurality of independently controlled zones is characterized by a thermal output greater than the others of the plurality of independently controlled zones.
